(19) United States
(12) Patent Application Publication
(10) Pub. No.: US 2011/0000148 A1
(43) Pub. Date: Jan. 6, 2011

(54) ANCHOR FOR HANDLING CONSTRUCTION ELEMENTS COMPRISING FIXED DIVERGENT ARMS

(76) Inventor: Marcel Arteon, Bayonne (FR)

Correspondence Address: LEYDIG VOIT & MAYER, LTD, 700 THIRTEENTH ST. NW, SUITE 300, WASHINGTON, DC, 20005-3960, US

(21) Appl. No.: 12/865,425

(22) PCT Filed: Feb. 9, 2009
(86) PCT No.: PCT/FR09/50207

§ 371 Date: Sep. 3, 2010

(30) Foreign Application Priority Data
Feb. 8, 2008 (EP) 08300079.4

(51) Int. Cl. E04G 21/14; B66C 1/66

(52) U.S. Cl. 52/125.5

(57) ABSTRACT

An anchor for construction elements, such as concrete panels, and including at least one flat part, an upper part for hanging on a handling engine and extending along a principal plane and a lower part for anchoring in the construction element. The lower part has two arms diverging in the direction of the lower end of the anchor, extending outside the principal plane, and forming, between them, an angle.

### FIELD OF THE INVENTION

The invention concerns a handling anchor for construction elements such as prefabricated blocks and panels, in particular in concrete or in compound material, designed to be fixed to a construction element to facilitate its handling, for the purpose of its movement.

### BACKGROUND

One commonly used anchor of this type is a dovetail anchor.

It is made up of a flat section whereof the upper part defines a gripping head which provides a link between the construction element and a handling engine designed to move it, the central part defines and body and the lower part, a foot.

The body and the foot are designed to be submerged within the material making up the construction panel and to adhere to this panel so that the anchor and the construction element form a transportable single assembly.

The dovetail shape is defined by the foot of the anchor which comprises two arms divergent in relation to each other along the direction opposite that of lifting, which define two support surfaces for the parts of the panel located above these arms, and thus a certain anchoring capacity.

During lifting, these arms consequently support the majority of the weight of the panel and the part of the panel interposed between these arms is the seat of significant compressive forces.

Under these conditions, it is possible for the angle of these arms in relation to the principal plane of the flat section to decrease, which results in a change in the anchoring capacity developed by these arms.

### SUMMARY OF THE INVENTION

The invention aims to resolve this drawback, economically while ensuring high performances and safety level, without adding any complementary frame under axial tension.

To this end, the invention concerns a handling anchor for construction elements, such as concrete panels, formed from at least one flat section, comprising an upper part for hanging on a handling engine, extending along a principal plane (P) and a part forming the body of the anchor and a part forming the foot of the anchor and designed to ensure anchoring in the construction element, this foot comprising two arms diverging in the direction of the lower end of the anchor and extending outside the principal plane (P) and forming, between them, a predetermined angle (γ), the diverging arms define a compression cone during the lifting of the construction element.

According to the invention, the anchor comprises at least one flat part connecting the two arms to each other to ensure maintenance of the predetermined angle (γ) between these two arms, and to form with the diverging arms, a stiffening case localized at the foot of the anchor.

According to another characteristic, it comprises two flat parts each integral with the lower end of one diverging arm, these two flat parts converging toward one another in the direction of the lower end of the anchor and being in contact with each other along their lower edges and defining converging arms for maintaining the predetermined angle (γ).

Advantageously, the two convergent arms are integral with each other by their lower edges.

Preferably, the anchor is formed from two flat sections, each comprising consecutive parts separated two by two by bending lines and defining a head part, a divergent arm and a maintenance arm, the first and second flat sections being arranged back-to-back.

According to another characteristic, the anchor is formed from a single flat section comprising consecutive parts separated two by two by bending lines and defining a first head part, a first divergent arm, a first maintenance arm, a second maintenance arm, a second divergent arm and a second head part.

According to another embodiment, it comprises, interposed between the head and the diverging arms, two opposite flat parts diverging in relation to each other in the direction of the end of the anchor forming active facets which, when the anchor is fixed to the construction element, ensure adhesion of said anchor to the construction material.

Moreover, it may comprise, interposed between the active facets and the diverging arms, intermediate facets converging towards each other in the direction of the anchor or parallel to each other.

Preferably, the diverging arms are at an angle in relation to the principal plane (P) by an angle between 45° and 80°.

When the diverging arms are angled in relation to the principal plane (P) by an angle substantially equal to 45°, the two active arms and the two maintenance arms can define a rectangular contour, preferably square.

In another case, the active arms each comprise a portion at an angle in relation to the principal plane (P) by an angle substantially equal to 70°, and a vertical portion parallel to the principal plane (P), consecutive to the angled portion, the maintenance arms each extending from a vertical portion.

According to another characteristic, the two flat parts forming the head are stuck against each other and comprise orifices for the passage of a lifting ring.

Differently, the two flat parts forming the head are separated from each other, the anchor comprising, for example, a cylindrical head interposed between the two flat parts.

According to another characteristic, two successive flat parts of the stiffening case define two by two an angle equal to or greater than 90°.

According to still another characteristic, the flat part consists of steel.

Preferably, the anchor comprises two raising fins extending along a longitudinal edge of the body of the flat part, each fin defining a tilt angle with the body of the flat part.

The invention also concerns a device for lifting and/or raising construction elements, comprising an anchor as defined above and an extension element having the general shape of a profile, provided with at least two opposite faces with a same tilt as the diverging arms of the anchor, and conformed so as to be able to cross the cavity defined by the stiffening case of the anchor and to extend on either side of this case with each of its two tilted faces extending the corresponding diverging arm according to the same tilt.

### BRIEF DESCRIPTION OF DRAWING FIGURES

The invention will be better understood and other aims, details and advantages thereof will appear more clearly upon reading the following description, done in reference to the appended drawings, provided solely as an example, in which:

FIG. 1 illustrates a perspective view of an anchor according to a first embodiment of the invention, in position within a construction panel for the purpose of its lifting;

FIG. 2 shows a front view of an anchor according to a second embodiment of the invention;

FIG. 3 is a perspective view of the anchor from FIG. 2;

FIG. 4 shows a front view of an anchor according to a third embodiment of the invention;

FIG. 5 is a side view of the anchor from FIG. 4;

FIG. 6 corresponds to a perspective view of the anchor from FIG. 4;

FIGS. 7, 8 and 9 are front, side and perspective views, respectively, of a third possible variation of embodiment of the anchor according to the invention;

FIGS. 10, 11 and 12 are front, side and perspective views, respectively, of a fourth possible variation of embodiment of the anchor according to.

FIGS. 13 and 14 represent another possible variation of embodiment of the invention.

FIGS. 15 to 20 illustrate another possible variation of embodiment of the invention.

### DETAILED DESCRIPTION

The anchor devices according to the invention were designed to enable handling, in particular lifting, of construction elements such as prefabricated concrete blocks or panels.

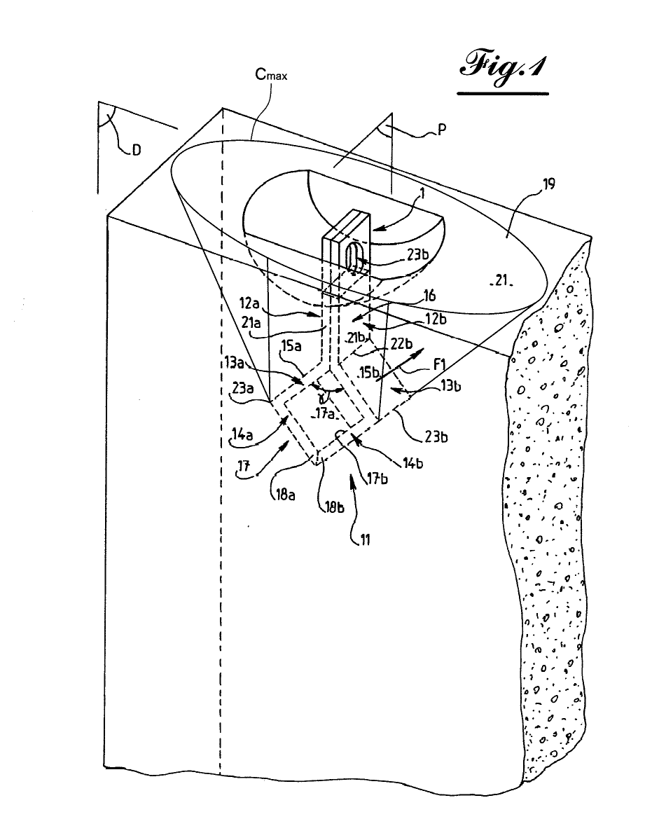

FIG. 1 shows a first embodiment of an anchor according to the invention generally designated by the reference 11.

It comprises a head part 1, a part 16 forming the body of the anchor and a part 17 forming the foot.

The anchor 11, with the exception of the head 1 which remains outside the material of the construction element and is adapted to be hung on a handling engine, is designed to be embedded in the material forming the construction element whereof the anchor facilitates handling.

In general, this construction element can be a concrete slab or panel 19 and the head 1 of the anchor is accessible from a free section 21 of the panel 19 within which a recess 22 or “reservation” has been formed allowing the head 1 to go past the anchor, while the body 16 and the foot 17 of the anchor are embedded in the concrete.

The anchor 11 according to FIG. 1 is made from two identical flat parts 12a, 12b, i.e. two stiff strips for example in metal whereof the thickness is small in relation to the width, which are each bent to define an active arm extending outside the principal plane of the flat part.

Each flat part is arranged in the panel such that its width is in the direction of the thickness of the panel.

The diverging arms define active surfaces 15a, 15b which, combined with the developed surface of the flat part, make it possible to urge the concrete both to adhesion and shearing to the right of the anchors created by the facets.

Due to their tilt in relation to a horizontal plane and to their depth within the concrete in relation to the head of the anchor since they are positioned at the foot of the anchor, these arms 13a, 13b define, upon lifting, a compression cone centered on the principal plane of the anchor, whereof the top is located toward the foot of the anchor and whereof the base extends around the head of the anchor. The amplitude of the base of the compression cone is more significant when the tilt a of one arm 13a, 13b is close to 45°, and weaker when this tilt is close to a horizontal plane, i.e. 0° tilt.

According to the invention, in order to keep the tilt of the diverging arms fixed in relation to the longitudinal plane P of the flat section upon lifting of the panel, the anchor 11 comprises two arms converging towards each other 14a, 14b, horizontally or along two intersecting planes and each extending in the extension of a diverging arm 13a, 13b in the direction of the foot of the anchor.

The two convergent arms 14a, 14b define, for the divergent arms 13a, 13b which they extend, means for maintaining the tilt of these divergent arms.

Indeed, the convergent arms in contact 14a, 14b act on the divergent arms 13a, 13b like stiffening members to avoid bending of these arms 13a, 13b under the effect of the weight exerted by the concrete overhanging these arms 13a, 13b during lifting of the concrete panel.

Moreover, the two convergent arms 14a, 14b are in contact with each other by their edges 18a, 18b opposite the divergent arms 13a, 13b, to define, with these divergent arms 13a, 13b, a deformation-resistant case, for example having a square transverse cross-section.

The contact edges 18a, 18b of the convergent portions 14a, 14b of the anchor are advantageously fixed to each other. This fixing is done, for example, by welding via a lug, or by bending when the anchor is made up of a single flat part.

Thus, contrary to the case of the aforementioned dovetail anchor, the tilt of the divergent arms 13a, 13b does not tend to change in relation to the principal plane P of the flat part and the concrete interposed between the two opposite arms 13a, 13b is not overcompressed.

Moreover, the internal surfaces 17a, 17b of the convergent arms 14a, 14b participate in the adhesion between the concrete and this anchor.

By the presence of the arms 14a, 14b which ensure maintenance of the tilt of the diverging arms 13a, 13b, the anchoring cone defined by these diverging arms 13a, 13b may be maintained constant.

For example, with these maintenance arms 14a, 14b, it is possible to maintain the anchoring cone constant with significant amplitude Cₘₐₓ defined by 45°—tilted arms, which is schematically illustrated in FIG. 1. Such a cone of amplitude Cₘₐₓ defines a significant anchoring or lifting capacity since it develops a volume of concrete as great as possible (volume defined by the cone Cₘₐₓ).

It is therefore particularly adapted to the lifting of very heavy elements of the order of 5 to 10 tons, for example.

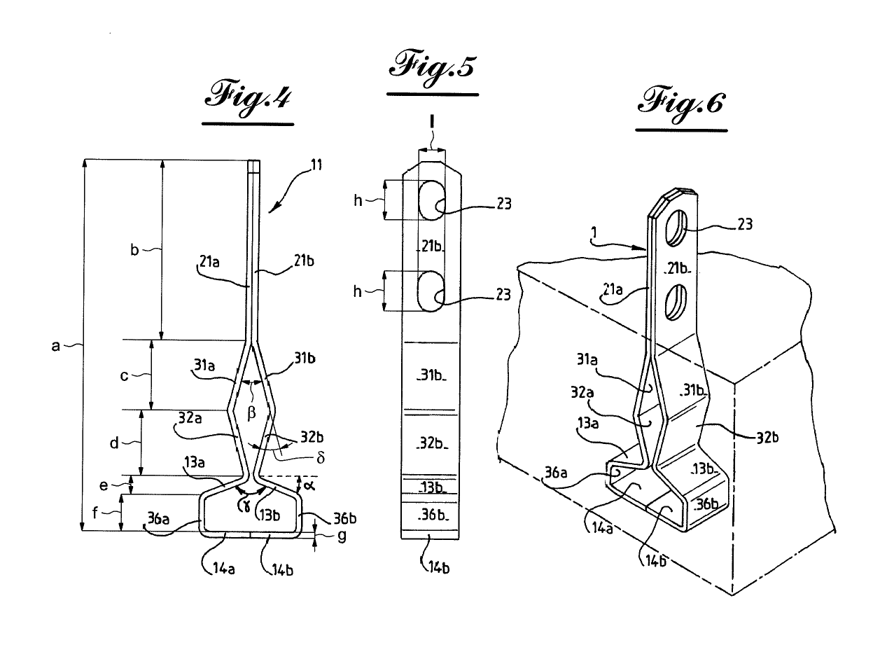

Also, they give the possibility of maintaining a cone constant with lesser amplitude obtained with diverging arms 13a, 13b, tilted by only 20° in relation to the horizontal which is illustrated in FIG. 6. The anchoring capacity of this cone is lower than that of the cone of the anchor of FIG. 1 since the volume of concrete developed by 20°—tilted arms is less than that developed by 45°—tilted arms.

But in both cases, the amplitude of the cone remains constant because of the presence of the arms 14a, 14b, maintaining the tilt of the diverging arms 13a, 13b, so that the anchor lifting force remains constant during the lifting of the construction element and/or subsequently to successive liftings.

The stiffening case, regardless of its shape, defines the foot of the anchor which is the active element in the concrete while generating compression areas upon the lifting.

The anchoring depth, i.e. the depth at which the case is found relative to the upper part of the concrete construction element determines the resistance value of the anchoring in the concrete.

There is in fact a correlation between the mechanical strength value and the anchoring depth.

Below, we describe different embodiments of anchors according to the invention.

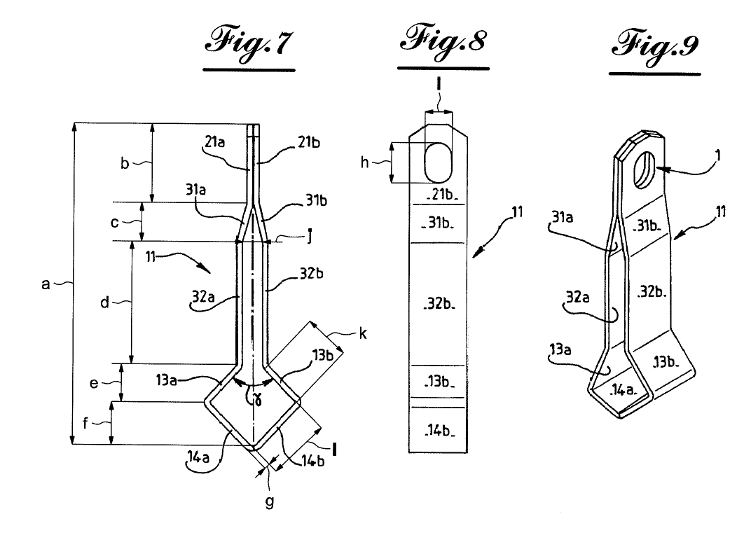

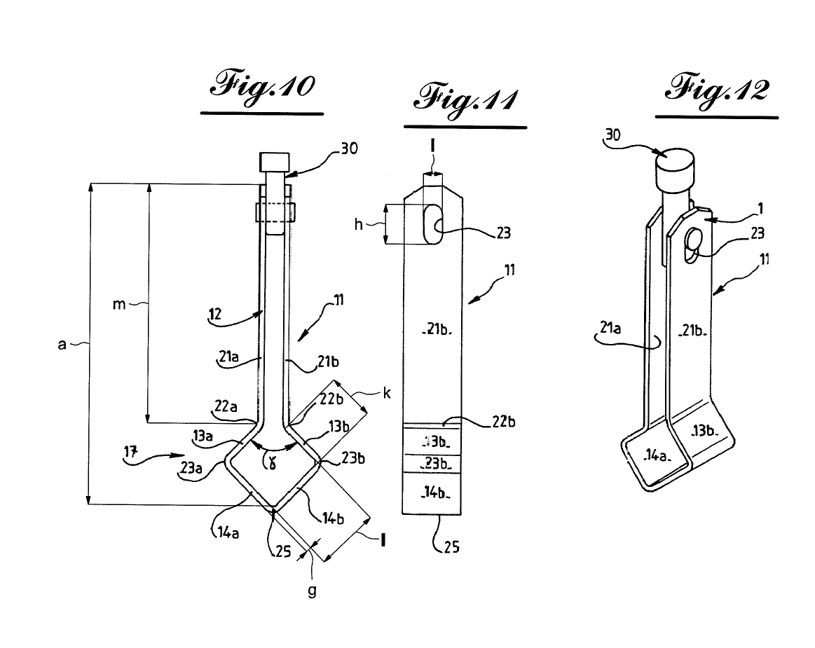

The anchors from FIGS. 1 to 3 and 7 to 12 comprise two divergent arms 13a, 13b arranged at the foot of the anchor i.e. for example at least 120 mm from the head of the anchor (see Table 1 below) and are intended to extend to at least a depth of 130 mm in the construction element.

These arms 13a, 13b are tilted at a 45° angle in relation to the horizontal direction and the convergent arms 14a, 14b define a right angle with the divergent arms 13a, 13b.

Thus, the case formed by the divergent 13a, 13b and convergent 14a, 14b arms has a square-shaped cross-section with relatively short sides. This square case extends in the construction element to be lifted with its diagonal parallel to the direction of lifting. Due to this square cross-section, the case is very stiff and practically deformation-resistant. And due to the 45° angle, the developed compression cone is significant.

The anchor in FIGS. 4 to 6, on the other hand, comprises two divergent arms always arranged at the foot of the anchor but defining an angle α of 20°.

This anchor comprises intermediate facets 31a, 31b, 32a, 32b which increase the adhesion surface of the anchor.

Furthermore, in this embodiment, the arms for maintaining the tilt angle of the diverging arms 14a, 14b extend along a horizontal plane and not a plane tilted at 45° as this is the case for the arms 14a, 14b of FIGS. 1 to 3 and 7 to 12.

These horizontal arms 14a, 14b are therefore closer to the divergent arms tilted at 20° in FIG. 4 than are the converging arms 14a, 14b of the 45°—tilted arms of FIG. 1, and thus define a case having a small height but which is still deformation-resistant. Thanks to this small height of the case, for a same length of body anchor, the anchor of FIG. 4 has a total length smaller than that of FIG. 7 and is particularly adapted to the transport of concrete slabs along a horizontal plane since in this case, the anchor extends along the smallest dimension of the slab, i.e. the thickness (see FIG. 6).

Moreover, for a same total anchor length, still due to the short case resulting from the 20° tilt of the divergent arms 13a, 13b and from the horizontality of the maintenance arms 14a, 14b, the divergent arms 13a, 13b at a tilt of 20° may be arranged closer to the lower end of the anchor than in the case of FIG. 7, the divergent arms of which are at a tilt of 45° and the maintenance arms are not horizontal but converge along two intersecting planes towards the lower edge of the anchor. The 20°—tilted arms of the anchor of FIG. 4 are therefore able to be arranged more deeply in a slab or a panel, than the divergent arms 13a, 13b of the anchor from FIG. 7. These 20°—tilted arms 13a, 13b being more deeply anchored in the concrete, may develop a comparable or even greater anchoring capacity than that of the 45°—tilted arms from FIG. 7, although the latter develop a more significant anchoring cone.

Each variation of embodiment will now be described in further detail.

According to the exemplary embodiment shown in FIG. 1, the anchor is formed by connecting two identical flat parts 12a, 12b, coming from a metallic strip which is smooth, as shown, or ribbed according to a non-illustrated embodiment.

Each flat part 12a, 12b is bent along two bending lines, to provide the flat part 12a, 12b with a principal part extending along a principal plane P, an active arm 13a, 13b extending outside the principal plane and a maintenance arm 14a, 14b extending the active arm and returning toward the principal plane.

As the different parts of the right flat part 12b in FIG. 2 are more visible than those of the left flat part 12a, it is the right flat part 12b which will be described below, this description of course being valid for the left flat part 12a as well.

The first bending line 22b defines, for the flat part 12b, the principal part 21b, extending along the principal plane P and designed to be stuck against the corresponding part 21a of the second flat part 12a. This principal part 21b bears, at its upper end, an orifice 23b into which a handling hook is designed to be engaged.

The active arm 13b extending from the bending line 22b outside the principal plane P defines, with the principal part 21b of the flat part 12b, an angle of approximately 135°.

Thus, in relation to a horizontal plane, the active surface of the divergent arm 15b is tilted by 45°.

As mentioned above, the divergent arms 15a, 15b generate, in the concrete, during lifting, a compression cone of significant amplitude, due to the 45° tilt relative to the horizontal plane of the divergent arms.

And the deformation-resistant case 17 formed by the active divergent arms and the convergent reinforcing arms, makes it possible to keep the tilt of the divergent arms fixed in relation to a horizontal plane.

In the embodiment illustrated in FIGS. 10 to 12, the anchor still comprises a deformation-resistant end case 17 positioned at the foot of the anchor but it is made from a single flat part 12 bent on itself. This single flat part is bent along the bending lines 22b and 23b to define the rectilinear part 21b, the aforementioned active arm 13b and the convergent arm 14b, then bent at 90° along the bend 25 of FIG. 10 to define the lower right corner of the deformation-resistant case 17. The flat part 12 is then bent along the lines 23a and 22a to define the convergent 14a, divergent 13a arms and the opposite rectilinear part 21a.

Moreover, according to this embodiment, the rectilinear parts 21a, 21b of the flat section are separated from each other and define a space for receiving a gripping head 30, for example cylindrical, either with a screw or not, or of any other shape adaptable to any gripping means. This separation further causes a greater volume of the foot of the anchor and of the concrete.

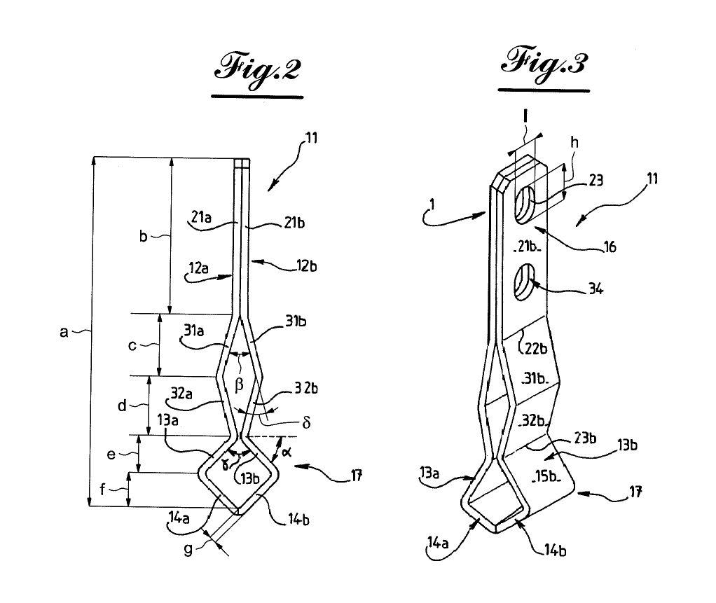

According to the exemplary embodiment illustrated in FIGS. 2 and 3, the anchor 11 is still made by connecting two identical flat sections, but these define an additional case with regard to the embodiment of FIG. 2, interposed between the body 16 of the anchor 11 and the first case 17.

More specifically, each flat section 12a, 12b comprises four bending lines, separating them in a rectilinear part 21b, an upper blade 31b extending outside the principal plane defined by the rectilinear part, a lower blade 32b returning the flat section toward the principal plane, the aforementioned active arm 13 and the aforementioned strengthening arm 14b.

The upper blades 31a, 31b of the two flat parts diverge in relation to each other in the direction of the foot of the anchor 11 and define an angular opening of approximately 15°. The lower blades 32a, 32b converge toward each other to be practically in contact with each other. They define support surfaces for the concrete part interposed between the divergent blades 31a, 31b upon lifting.

The upper blades 31a, 31b define intermediate active adhesion portions between the anchor and the concrete, which develop a very weak compression cone, given the tilt of approximately 80° of these blades in relation to a horizontal plane.

The anchor comprises, in addition to the orifice 23 for the passage of the handling hook, a passage slit 34 for a metallic reinforcement.

The blades 31a, 31b and the divergent 13a, 13b and convergent 14a, 14b arms combined with the developed surface of the flat part make it possible to bias the concrete both toward adhesion and shearing to the right of the anchors created by the facets.

According to the embodiment shown in FIGS. 7 to 9, the anchor is also made using two identical flat parts defining an end case 17 having a square transverse cross-section, and upper active blades 31a, 31b, but the lower blades 32a, 32b do not converge toward each other. They are, on the contrary, parallel to each other. They therefore do not define a support surface for the concrete part interposed between the divergent blades 31a, 31b, but simply an internal longitudinal volume leading to the square internal volume of the end case 17.

FIGS. 4 to 6 illustrate another embodiment of an anchor formed from two identical metallic flat parts. The particularity of this embodiment resides in particular in the fact that the active divergent arms 13a, 13b define a tilt angle of approximately 20° relative to a horizontal plane which develops an a priori weaker compression cone than that of the divergent arms at 45° in FIGS. 1 to 3 and 7 to 12.

In this case, each divergent arm 13a, 13b is extended by a substantially vertical flat portion 36a, 36b, itself extended by the aforementioned strengthening arm 14a, 14b which also extends along a horizontal plane.

TABLE 1
Dimensions of the illustrated anchors

| Letter marking | | | | | | | | |
|---|---|---|---|---|---|---|---|---|
| the relevant | Anchor | | Anchor | | Anchor | | Anchor | |
| dimension | FIG. 2 | | FIG. 4 | | FIG. 7 | | FIG. 10 | |
| a | 200 | | 185 | | 160 | | 160 | |
| b | 155 | 85 | 160 | 90 | 118 | 40 | 121 | — |
| c | | 35 | | 35 | | 78 | | — |
| d | | 35 | | 35 | | | | — |

| | | | | |
|---|---|---|---|---|
| e | 20 | 9 | 42 | — |
| f | 20 | 16 | | — |
| g | 4 | 3 | 3 | — |
| h | 20 | 20 | 20 | 20 |
| i | 14 | 14 | 14 | 14 |
| j | — | — | 18 | — |
| k | — | — | 25 | 25 |
| l | — | — | 30 | 30 |
| m | — | — | — | 121 |

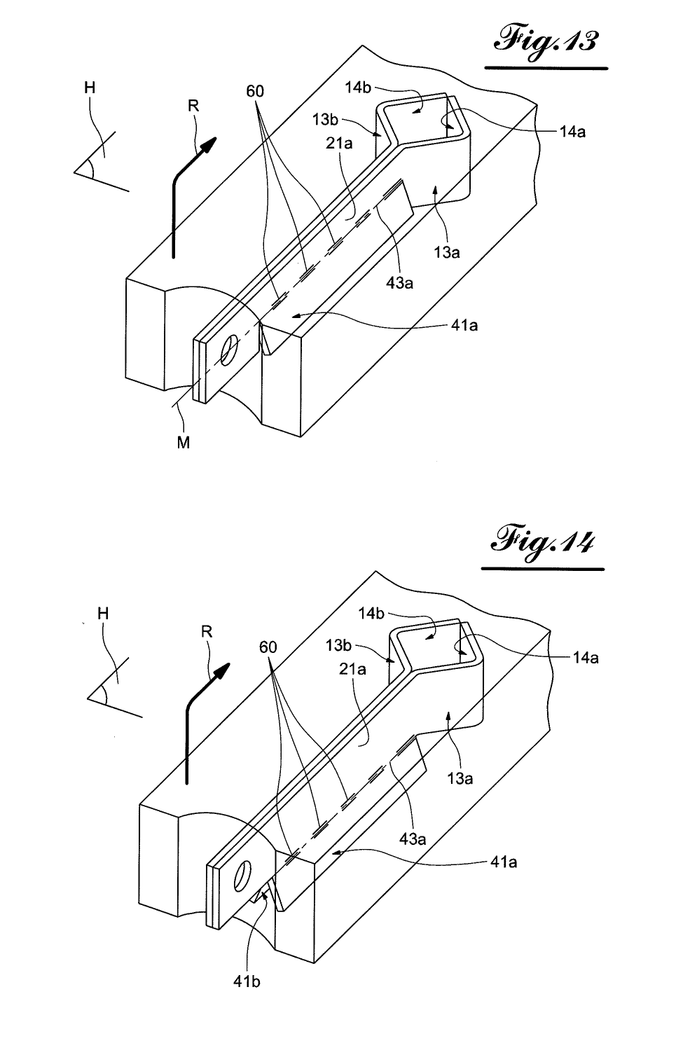

Moreover, according to the variation of embodiment illustrated in FIG. 13 or 14, a square stiffening case anchor as described for FIG. 1 is provided with raising fins 41a, 41b.

These fins 41a, 41b are formed by a flat part extending laterally beyond the longitudinal edge 43a of the body 21a of the anchor, which is bent along a line 43a coinciding with the longitudinal edge 43a of the body 21a in order to form an angle of about 20°.

The two fins 41a, 41b are symmetrical in relation to the P plane.

These fins 41a, 41b define concrete compression surfaces during the raising of the construction element in the direction illustrated by the marked arrow R in FIG. 13 or 14.

Ribs 60, schematically illustrated by sets of lines in FIGS. 13 and 14, are punched in the folds of the fins 41a, 41b and have the purpose of increasing resistance to unfolding, they are located in the angle of the fins.

The example of FIG. 13 is also an anchor provided with a stiffening case and raising fins 41a and 41b but the lines jointing the latter to the body 21a, 21b of the anchor pass through the middle axis M of the anchor and transverse slots (only one of which is visible in FIG. 15) are made in the body of the anchor from the longitudinal edge 43a up to the middle axis M.

By making the fins 41a, 41b in the actual body of the flat part it is possible to save material relatively to the fins of the anchor of FIG. 14 which require additional material. But the making of the latter is simpler since it does not require forming slots within the body of the flat part.

The fins 41a and 41b act in minority in adhesion under axial tension and in majority by developing a compression cone raising the anchoring since they are tilted at 20° as marked in FIGS. 13 and 14.

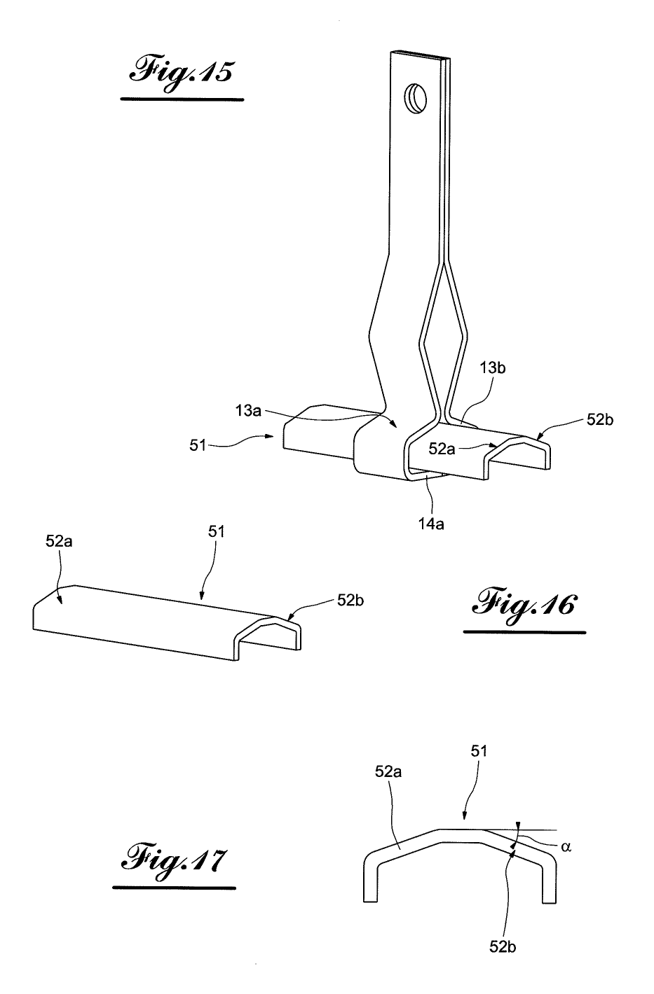

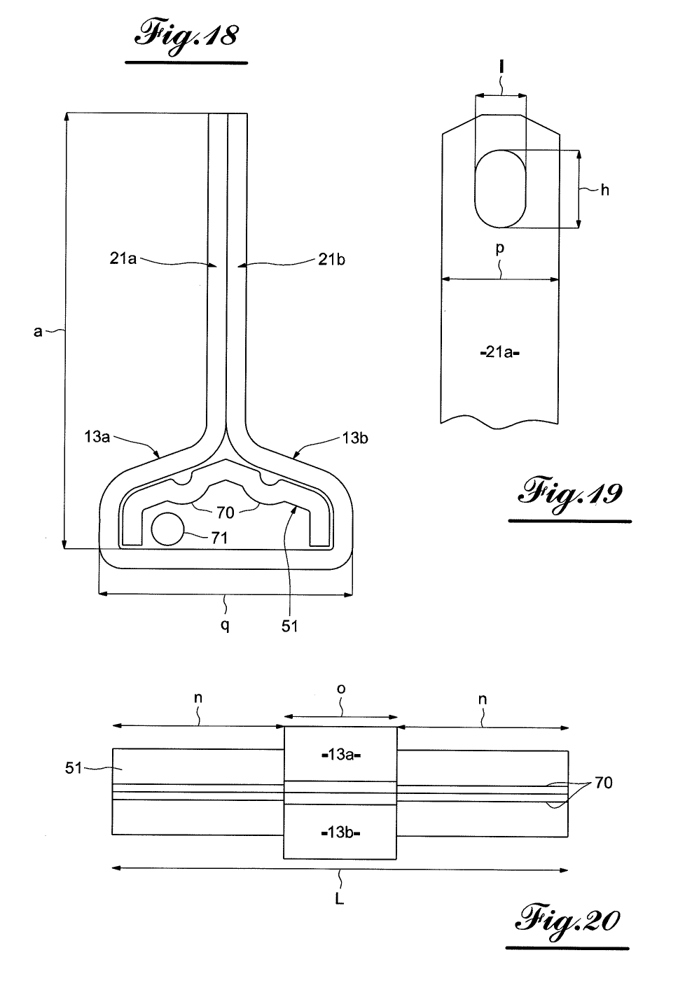

In the example illustrated in FIGS. 15 to 20, a remedy is found to the a priori small amplitude of the anchoring cone developed by an anchor provided with 20°—tilted diverging arms 13a, 13b, by extending these arms with an extension element 51, introduced into the stiffening case of the anchor and provided with two faces 52a, 52b with the same tilt as the diverging arms 13a, 13b, i.e. tilted by 20° in relation to the horizontal.

The tilted faces 52a, 52b develop on either side of the stiffening case, anchoring cones of the same amplitude as the cone C_{inf} developed by the stiffening case which increases the anchoring capacity of the anchor.

The extender 51 of FIG. 18 comprises two ribs 70 increasing its stiffness.

One or more frames 71 may be provided additionally.

This extender 51 may for example have a length L of 120 mm and jut out by 45 mm (n) on either side of the stiffening case. The latter may have a width of 30 mm (o), just like the width p of the body of the flat part 21a of the anchor.

Comparative studies conducted by numerical simulation have shown that adding the extension element 51 it was possible to increase the performance of the anchor in terms of 33% tensile strength for tensile tests, as illustrated in Table 2 below:

TABLE 2
Comparison of the performances of anchors
with and without any extender

| | Anchor without | | | | | | | |
|---|---|---|---|---|---|---|---|---|
| | any extender | | | | Anchor with extender | | | |
| | FIG. 6 | | | | FIG. 19 | | | |
| Type of concrete | 15 | MPa | 25 | MPa | 15 | MPa | 25 | MPa |
| Tensile strength | 62 | kN | 62 | kN | 83 | kN | 83 | kN |

| | | | | |
|---|---|---|---|---|
| Type of failure | steel | steel | steel | steel |

An extender of this type may be used as a replacement for the intermediate tilted facets 31a, 31b illustrated in FIG. 4 which operate with adhesion. Or else, it may be used as an addition to the anchors of FIGS. 1 to 12, mainly for thin slabs and with tilt angles from 20 to 45° by increasing the compression cone and the adhesion.

As illustrated in FIGS. 18 to 20, in this case, the anchor with 20°—tilted diverging arms 13a, 13b is without any active facets, with the bodies 21a, 21b of the flat part only extending along a main plane P, and comprises an extension element 51 of the same type as the one described for FIG. 19.

In the illustrated example, the extender extends on either side of the anchor over a length of 120 mm.

The anchor and the extender 51 are maintained in predetermined positions during the casting of the construction element.

The extension element 51 increases the compression cone and more performing and shorter anchoring may thereby be achieved and it may therefore be used in very thin slabs.

It is possible to make by bending of a metal sheet a one-piece anchor defining the head, the body, the stiffening case and the extender element, providing more economical making than when the anchor and the extender are as separate parts.

The particularities of the embodiments of the anchor described above, such as the square sectional shape of the case, the horizontal extension of the converging arms, the 10, 20, . . . 45° tilt of the diverging arms, the presence or the absence of intermediate facets 31, their number, may be combined with each other in order to define optimum anchoring depending on the construction element to be lifted.

Depending on the needs, the anchors according to the invention may include alone or as a combination, either one of the above particularities, i.e.:
intermediate facets 31a, 31b with variable length and tilts
a stiffening case, the diverging arms of which 13a, 13b are tilted at 45° and develop a significant anchoring cone
a case with 20°—tilted diverging arms 13a, 13b (other figures)
an anchor, the flat part (14a, 14b) of which ensuring the function of maintaining the tilt angle of the diverging arms 13a, 13b includes a horizontal portion, this flat part 14a, 14b may consist of a single part when the anchor is formed by a single flat part, or by two distinct flat parts when the anchor is formed by two combined flat parts
or an anchor which includes as a means for maintaining the tilt of the diverging arms 13a, 13b a portion with various tilted faces two by two
an anchor provided with an extension element as an addition
or further raising fins as illustrated in FIG. 13 notably.

As shown by the description just provided and the figures, the anchor according to the invention presents major advantages relative to the anchors of the prior art.

It prevents the divergent active arms from bending under the weight of the concrete upon lifting, thanks to the means for maintaining the tilt of these arms, formed by the convergent strengthening arms.

It is particularly adapted to the lifting of thin panels or nets.

Indeed, upon lifting of the concrete panel, the anchoring capacity developed by the arms tilted between 10° and 45° relative to a horizontal plane is more significant than that developed by horizontal arms, i.e. perpendicular to the body of the anchor and having 0° tilt in relation to a horizontal plane. The anchor can therefore have a smaller length than that of anchors of the known type whereof the feet develop a less significant anchoring capacity, and can therefore be located in the direction of the width of a thin panel, or a sheet.

Moreover, the compression force defined by the divergent arms is directed along a normal preferred direction to the active surface of a arm as shown by the arrow Fl in FIG. 1, and is therefore inscribed in the plane D of the concrete slab or panel 19. Thus, contrary to anchors whereof the foot is disc-shaped and deploys, because of its circular shape, forces on all the 360° of the disc, the anchor according to the invention develops compression forces in the direction of the slab having the largest size and therefore never along the direction of smaller size, avoiding breaking in this direction.

Moreover, an anchor of this type is made by a simple and inexpensive manufacturing method, based on the bending of only one or two flat sections.

Moreover, in all of the embodiments, none of the angles between two consecutive facets of the flat section define an acute angle, which avoids any material weakening which would be due to bending and avoids bending rework.

Moreover, in the illustrated embodiments, the angles between diverging arms 13a, 13b and converging arms 14a, 14b are equal to or greater than 90°.

Indeed, the thickness of the flat part used, which is selected to be of the order of one millimeter and of at least 3 mm in the illustrated exemplary anchors (see Table 1, line <<c>>), then the anchor used is selected to have a loading capacity of 20 to 50 tons, makes it difficult or even impossible to define an acute angle between a diverging arm 13a, 13b and the following horizontal or converging arm 14a, 14b, even with manufacturing of the anchor with two assembled flat parts.

The thickness of the flat part (3, 4, 5, 8 mm or more) in fact defines a mechanical strength if 1, 3, 5 tons or more, with which the anchor may be related to the weight of the construction elements to be handled.

1. An anchor for lifting construction elements, the anchor being formed from at least one flat part and comprising:
an upper part for hanging on a handling engine and extending along a principal plane;
a body;
a foot for anchoring in the construction element, wherein
the foot comprises two arms diverging in a direction toward a lower end of the anchor, extending outside the principal plane, and forming an angle between the two arms, and
the two arms define a compression cone upon lifting the construction element; and
at least one flat part connecting the two arms to each other to maintain the angle between the two arms and to form, with the arms, a stiffening case at the foot of the anchor.

2. The anchor according to claim 1, comprising first and second flat parts, each flat part being integral with a lower end of one of the arms, the first and second flat parts converging toward each other in the direction of the lower end of the anchor, being in contact with each other along lower edges, and defining converging arms for maintaining the angle.

3. The anchor according to claim 2, wherein the two converging arms are integral with each other at their lower edges.

4. The anchor according to claim 2, each flat part comprising consecutive parts separated, two-by-two, by bending lines and defining a head part, a divergent arm, and a maintenance arm, the first and second flat parts being arranged back-to-back.

5. The anchor according to claim 2, formed from a single flat part and comprising consecutive parts separated, two-by-two, by bending lines and defining a first head part, a first divergent arm, a first maintenance arm a second maintenance arm, a second divergent arm, and a second head part.

6. The anchor according to claim 5, comprising, interposed between the head and the first and second divergent arms, two opposite flat parts diverging in relation to each other in the direction of the end of the anchor and forming active facets which, when the anchor is firmly fixed to the construction element, ensure adhesion to the construction element.

7. The anchor according to claim 6, comprising, interposed between the active facets and the first and second divergent arms, intermediate facets converging toward each other in the direction of the end of the anchor or parallel to each other.

8. The anchor according to claim 5, wherein the first and second divergent arms are tilted in relation to the principal plane by an angle that is between 45° and 80°.

9. The anchor according to claim 8, wherein
each of the first and second divergent arms is tilted in relation to the principal plane by an angle substantially equal to 45°, and
the first and second divergent arms and the two maintenance arms define a rectangular contour.

10. The anchor according to claim 8, wherein
each of the first and second divergent arms comprises
a tilted portion in relation to the principal plane, tilted at by an angle substantially equal to 70°, and
a vertical position parallel to the principal plane, consecutive to the tilted portion; and
each of the first and second maintenance arms extends from a vertical portion of one of the first and second divergent arms.

11. The anchor according to claim 4, wherein the first and second flat parts forming the head part are against each other and comprise orifices for the passage of a lifting ring or of an additional frame.

12. The anchor according to claim 4, wherein
the first and second flat parts are separated from each other, and
the anchor comprises a head interposed between the first and second flat parts.

13. The anchor according to claim 1, wherein two successive flat parts of the stiffening case define, two-by-two, an angle of at least 90°.

14. The anchor according to claim 13, wherein the flat parts are steel.

15. The anchor according to claim 1, further comprising two raising fins extending along a longitudinal edge of the body, each fin defining a tilt angle with the body.

16. A device for lifting construction elements, comprising an anchor according to claim 5 and an extension element including at least two opposite faces with the same tilt as the first and second divergent arms of the anchor, and crossing a cavity defined by the stiffening case extending on either side of the stiffening case, with each of the faces extending the corresponding divergent arm along the same tilt.
